(19) United States
(12) Patent Application Publication
(10) Pub. No.: US 2026/0158829 A1
(43) Pub. Date: Jun. 11, 2026

(54) PNEUMATIC TIRE

(71) Applicant: Toyo Tire Corporation, Itami-shi (JP)

(72) Inventor: Ayaki TANAKA, Itami-shi (JP)

(73) Assignee: Toyo Tire Corporation, Itami-shi (JP)

(21) Appl. No.: 19/279,066

(22) Filed: Jul. 24, 2025

(30) Foreign Application Priority Data
Aug. 9, 2024 (JP) 2024-134709

(51) Int. Cl. B60C 13/02; B60C 11/03; B60C 11/12; B60C 11/13

(52) U.S. Cl. CPC B60C 13/02; B60C 11/0306; B60C 11/1236; B60C 11/1353; B60C 2011/1213; B60C 2011/1254; B60C 2011/1361

(57) ABSTRACT

A pneumatic tire includes a tread, side walls, and shoulders and has an angular contact end shape. The shoulder has a shoulder surface on which a corner is substantially absent, and the shoulder surface has a curved surface in an arc shape that is curved to project outward in a tire axial direction. For example, the curved surface has a curvature radius of 5 mm to 15 mm.

### CROSS REFERENCE TO RELATED APPLICATION

The entire disclosure of Japanese Patent Application No. 2024-134709 filed on Aug. 9, 2024 including the specification, claims, drawings, and abstract is incorporated herein by reference in its entirety.

### TECHNICAL FIELD

The present disclosure generally relates to a pneumatic tire, and more particularly to a heavy loading tire suitable for large-sized vehicles such as a truck or a bus.

### BACKGROUND

Pneumatic tires for heavy loading typically have angular contact end shapes to extend the contact surfaces of treads (for example, see JP 2017-136936 A and JP 2020-1617 A).

In addition, as disclosed in JP 2020-1617 A, the shoulders preferably extend outward in the tire axial direction. In this case, the contact area increases in mud, sand, and on a snowy road or the like. Furthermore, bent portions that protrude outward in the tire axial direction are formed at the shoulders of a tire disclosed in JP 2020-1617 A.

### SUMMARY

In recent years, there has been demand for improved quietness and fuel efficiency in large vehicles such as trucks and buses, but for conventional heavy loading tires, traction performance has been prioritized and aerodynamic performance has hardly been considered. Thus, heavy loading tires typically have a large air resistance and are prone to generate wind noise. Furthermore, particularly in vehicles such as an electric vehicle not equipped with an engine, noise generated from the tires is likely to be annoying, and thus it is important to improve the aerodynamic performance of the tires.

A pneumatic tire according to the present disclosure includes a tread, side walls, and a shoulder, the shoulder being located between a contact end of the tread and the side wall, the pneumatic tire having a corner at the contact end, wherein the shoulder has a shoulder surface on which a corner is substantially absent, and the shoulder surface has an arc shape that is curved to project outward in the tire axial direction.

The pneumatic tire according to the present disclosure has excellent aerodynamic performance and contributes to, for example, improvement in the quietness and fuel efficiency of a vehicle. The pneumatic tire according to the present disclosure is suitable for heavy loading tires and is particularly suitable for vehicles such as an electric vehicle not equipped with an engine.

### BRIEF DESCRIPTION OF DRAWINGS

Embodiment(s) of the present disclosure will be described based on the following figures, wherein:

FIG. 1 is a perspective view illustrating a pneumatic tire that is an example of an embodiment;

FIG. 2 shows a suitable mounting arrangement of the pneumatic tires in a vehicle as an example of the embodiment;

FIG. 3 is a plan view illustrating the pneumatic tire that is an example of the embodiment;

FIG. 4 is a plan view showing a region R1 of a tread;

FIG. 5 is a plan view showing a region R2 of the tread;

FIG. 6 is a side view illustrating the pneumatic tire that is an example of the embodiment;

FIG. 7 is a side view illustrating the pneumatic tire that is an example of the embodiment, and an enlarged view of a part of a tire side surface;

FIG. 8 is a perspective view showing a shoulder and the vicinity thereof;

FIG. 9 is a cross-sectional view taken along line AA of FIG. 3;

FIG. 10 is an enlarged view of the shoulder in FIG. 9 and the vicinity thereof; and

FIG. 11 illustrates a part of an outline along a tire surface and the profile surface of a side wall in FIG. 9.

### DETAILED DESCRIPTION OF EMBODIMENTS

An exemplary embodiment of a pneumatic tire according to the present disclosure will be specifically described below with reference to the accompanying drawings. The embodiment described below is merely exemplary, and the present disclosure is not limited to the embodiment. In addition, selectively combining the constituent elements of the following embodiment is included in the present disclosure.

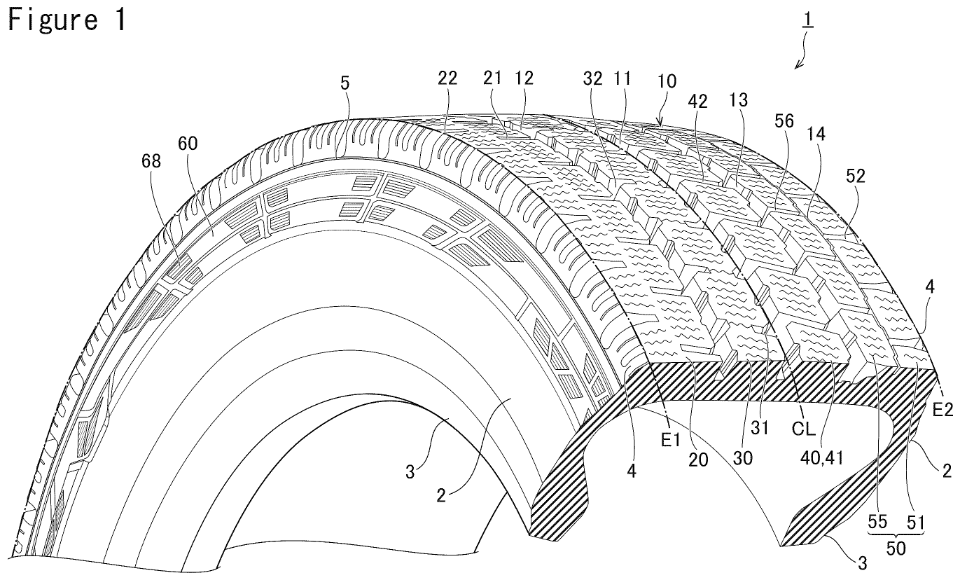

FIG. 1 is a perspective view illustrating a pneumatic tire 1 according to an example of the embodiment. As shown in FIG. 1, the pneumatic tire 1 includes a tread 10 that is a part to come into contact with a flat road surface, a pair of side walls 2, a pair of beads 3, and a pair of shoulders 4. The bead 3 is a portion to be fixed to the rim of a wheel. The shoulder 4 is a portion located between a contact end E1 or E2 of the tread 10 and the side wall 2 and is also referred to as a buttress. The side walls 2, the beads 3, and the shoulders 4 extend inward in the tire radial direction from both left and right ends (contact ends E1 and E2) of the tread 10 and form tire side surfaces.

In the present embodiment, regions from the contact ends E1 and E2 of the tread 10 to side ribs 5 are defined as the shoulders 4. In other words, the contact ends E1 and E2 serve as the boundary positions between the tread 10 and the shoulders 4, and the side rib 5 serves as a boundary position between the side wall 2 and the shoulder 4. The side ribs 5 are protrusions that are continuously formed in annular shapes in the tire circumferential direction on the left and right side surfaces of the tire. For example, the side rib 5 is formed at the boundary position between a sector and a side plate of a mold when the tire is molded. For the sake of explanation, the right side of FIG. 1 is defined as the right side of the pneumatic tire 1, whereas the left side of FIG. 1 is defined as the left side of the pneumatic tire 1.

The pneumatic tire 1 is configured such that the contact ends E1 and E2 have angular shapes, and corners are formed at the contact ends E1 and E2. In the present specification, the corners mean acute bent portions, and lines extending along the tire circumferential direction are formed at the contact ends E1 and E2. Note that the corners include a slightly rounded corner, to be specific, an acute bent portion with a curvature radius less than 0.1 mm is defined as a corner. The pneumatic tire 1 having the angular contact end shapes can extend the contact surface of the tread 10. The pneumatic tire 1 is a heavy loading tire suitable for large-sized vehicles such as a truck or a bus.

The contact ends E1 and E2 of the tread 10 are defined as both ends of an area (contact surface) in the tire axial direction, the area coming into contact with a flat road surface when a normal load is applied in a state in which the unused tire is mounted on a regular rim and is filled with air to a normal internal pressure. In addition, a tire maximum width position P, which will be described later, is also defined under the same conditions as the contact ends E1 and E2.

In this case, “regular rim” is a rim defined for each tire in the standards of a market where the tire is used. The rim refers to “application rim” in the JATMA, refers to “Approved Rim Contours” in the TRA, and refers to “Approved Rim” in the ETRTO. “Normal internal pressure” is an air pressure defined for each tire in the standards of a market where the tire is used. The air pressure refers to an air pressure corresponding to the maximum load capacity of a target tire in the JATMA, refers to an air pressure corresponding to the maximum load capacity of a target tire in a table “TIRE LOAD LIMITS AT VARIOUS COLD INFLATION PRESSURES” in the TRA, and refers to “INFLATION PRESSURE” in the ETRTO. “Normal load” is an allowable load defined for each tire in the standards of a market where the tire is used. The normal load refers to the single-wheel maximum load capacity value of the target tire in the JATMA, refers to the single-wheel maximum load capacity value of the target tire in the table in the TRA, and refers to the single-wheel “LOAD CAPACITY PER AXLE” value of the target tire in the ETRTO.

The pneumatic tire 1 has a tread pattern including a plurality of blocks, and main grooves 11, 12, and 13 that are tire circumferential grooves separating the blocks. The main groove 11 is located on a tire equator CL and is continuously formed in an annular shape in the tire circumferential direction. The equator CL is a virtual line that extends along the tire circumferential direction and passes through the center of the tread 10 in the tire axial direction. The main groove 12 is located between the equator CL and the contact end E1, and the main groove 13 is located between the equator CL and the contact end E2. The main grooves 12 and 13 are both continuously formed in an annular shape in the tire circumferential direction.

The tread 10 includes a first shoulder block 20, a first center block 30, a second center block group 40, and a second shoulder block group 50 sequentially from the contact end E1. The main groove 11 separates the first center block 30 and the second center block group 40, the main groove 12 separates the first shoulder block 20 and the first center block 30, and the main groove 13 separates the second center block group 40 and the second shoulder block group 50. The blocks of the tread 10 are projections protruding outward in the tire radial direction and may be referred to as lands in the tire industry.

The tread 10 includes a narrow groove 14 extending in the tire circumferential direction. The second shoulder block group 50 includes an outer shoulder block 51 and an inner shoulder block 55 that are separated by the narrow groove 14. The narrow groove 14 is a tire circumferential groove that is located between the main groove 13 and the contact end E2 with a smaller groove width than the main groove and is continuously formed in an annular shape in the tire circumferential direction. The narrow groove 14 increases the edges of the block to improve the traction performance while securing the rigidity of the second shoulder block group 50. The outer shoulder block 51 and the inner shoulder block 55 that are separated by the narrow groove 14 can support each other, for example, when a force is applied to press the blocks in the lateral direction.

The tread 10 further includes horizontal grooves extending in the tire axial direction. The horizontal grooves include horizontal grooves 21, 22, 31, and 32 that are terminated in the blocks and horizontal grooves 42, 52, and 56 that divide the blocks in the tire circumferential direction. The first shoulder block 20 and the first center block 30 are rib-shaped blocks that extend continuously in the tire circumferential direction. These blocks will be specifically described later. The second center block group 40 and the second shoulder block group 50 are composed of a plurality of second center blocks 41, the plurality of outer shoulder blocks 51, and the plurality of inner shoulder blocks 55. These blocks are separated by the horizontal grooves 42, 52, and 56 in the tire circumferential direction. Such a tread pattern remarkably contributes to compatibility between traction performance and resistance to partial wear, and also contributes to improvement in aerodynamic performance by the synergistic effect with the shape of the tire side surface, which will be described later.

The tread pattern is preferably formed with variable pitches (unequal intervals) changing in the tire circumferential direction. In this case, the pattern noise is reduced and quietness improves. For example, the tread pattern is configured such that the total number of pitches is 20 to 30 and three or more patterns are used with different pitch lengths.

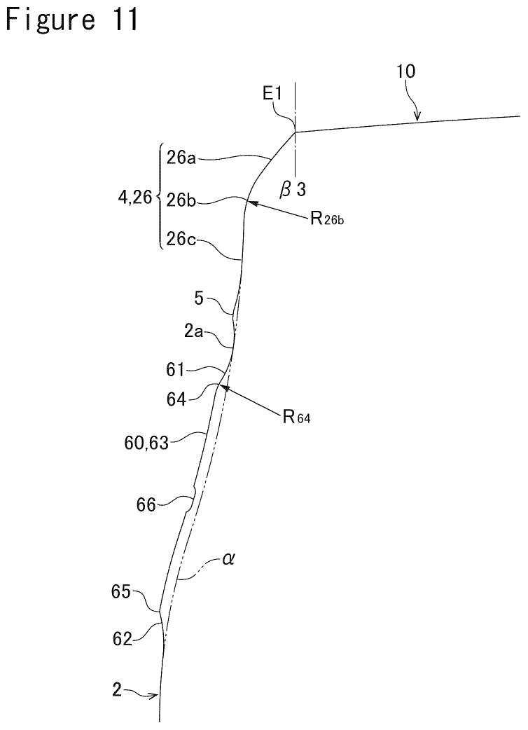

The side wall 2 has a side protector 60 protruding outward in the tire axial direction. The side protector 60 is a side block protruding outward in the tire axial direction from a profile surface α (see FIG. 11 described later) of the side wall 2. The side protector 60 improves side-cut resistance performance and suppresses damage to the side wall 2. The side protector 60 is located between the tire maximum width position P on the profile surface α, on which the length is maximized in the tire axial direction, and the side rib 5 and is continuously formed in an annular shape in the tire circumferential direction. As will be specifically described later, the outer portion of the side protector 60 in the tire radial direction does not have an angular shape and is gradually curved to project outward in the tire axial direction.

The side wall 2 may have characters, numbers, and symbols or the like, which are referred to as a serial. The serial includes, for example, information such as a size code, the time of production (production year/week), and a production site (factory code). Moreover, the side protector 60 includes a serration 68 that is a fine relief structure extending in the tire circumferential direction. The serration 68 is formed on the surface of the side protector 60 and contributes to improvement in the aerodynamic performance of the tire. Moreover, a serial may be formed by a fine relief structure extending in the tire circumferential direction, and the serial may have the function of the serration.

The shoulders 4 are formed by the side surfaces of the first shoulder block 20 and the outer shoulder blocks 51 that are oriented outward in the tire axial direction. In other words, the first shoulder block 20 and the outer shoulder blocks 51 form the shoulders 4. As will be specifically described later, the shoulder 4 has a surface on which a corner is substantially absent, and the surface has an arc shape that is curved to project outward in the tire axial direction. The surface of the shoulder 4 is gradually curved into an arc shape, thereby smoothly passing an airflow along the side surface of the tire. This effectively improves the aerodynamic performance of the tire, thereby reducing the air resistance and improving quietness. For example, the arc shape of the shoulder 4 has a curvature radius of 5 mm to 15 mm.

For the rubber composition and internal structure of the pneumatic tire 1, a conventionally known configuration is applicable. The pneumatic tire 1 includes, for example, a carcass, a belt, an inner liner, and a cap ply. The carcass is a cord layer covered with rubber and forms the frame of the tire that is resistant to a load, an impact, and an air pressure or the like. The carcass is composed of two carcass plies and has a radial structure in which a carcass cord is disposed in a direction orthogonal to the tire circumferential direction. The inner liner is a rubber layer for keeping an air pressure and is provided inside the carcass.

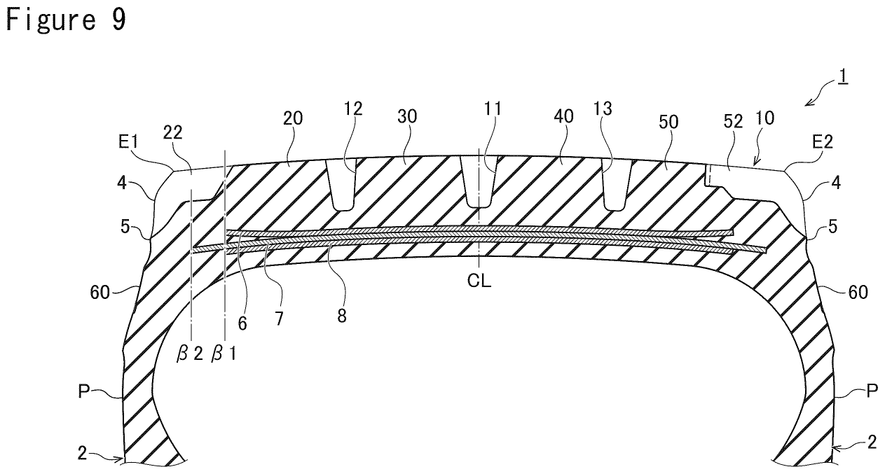

In addition, the pneumatic tire 1 preferably includes a plurality of belts (see FIG. 9 described later). The belt is a reinforcing belt disposed between the rubber constituting the tread 10 and the carcass. The belt strongly fastens the carcass to increase the rigidity of the tire. For example, the belt is configured such that a metallic cord is covered with rubber. In view of improvement in handling and aerodynamic performance, the arc shape of the shoulder 4 is preferably formed in a region outside the belt end (see FIG. 9 described later) in the tire axial direction.

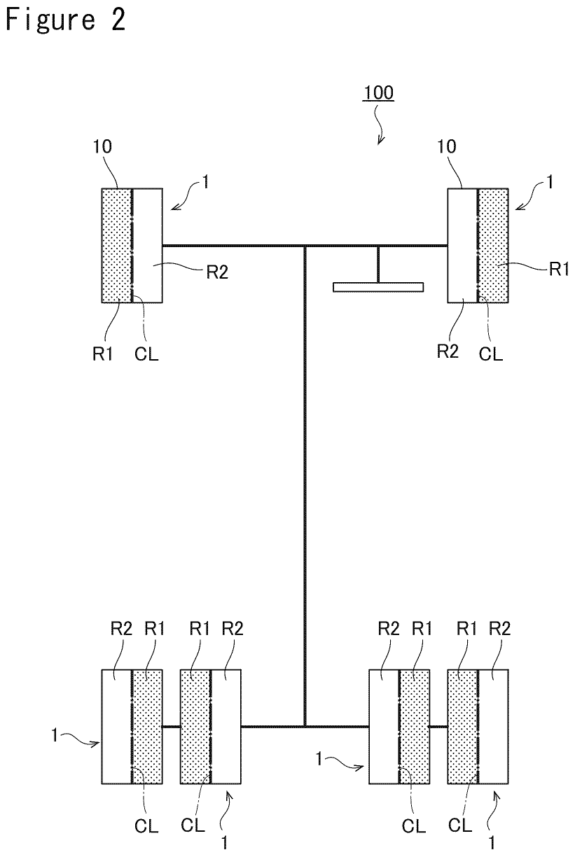

FIG. 2 shows a suitable mounting arrangement of the pneumatic tires 1 in a vehicle 100. In FIG. 2, dot hatching is added to regions R1 of the treads 10. The first shoulder block 20 and the first center block 30 (collectively referred to as “first block”) are disposed like ribs in the region R1. The region R1 is a region from the equator CL to the contact end E1. In a region R2 from the equator CL to the contact end E2 of the tread 10, columns of a plurality of blocks (collectively referred to as “second block”) constituting the second center block group 40 and the second shoulder block group 50 are disposed.

As shown in FIG. 2, the pneumatic tire 1 is a tire mounted in a specified orientation with respect to the vehicle 100. When used as a front tire, the pneumatic tire 1 is mounted such that the region R1 of the tread 10 is located on the outside of the vehicle. In other words, when the pneumatic tire 1 is mounted as a front tire to the vehicle 100, the tread 10 has the rib-shaped first block that extends continuously in the tire circumferential direction in a region located on the outside of the vehicle with respect to the equator CL and has the second block separated in the tire circumferential direction in a region located on the inside of the vehicle with respect to the equator CL. In this case, compatibility between the traction performance and the resistance to partial wear can be satisfactorily achieved.

In general, the traction performance and the resistance to partial wear are mutually contradictory features and thus it is difficult to obtain compatibility. However, the rib-shaped first block continuously extending in the tire circumferential direction has high rigidity and improves resistance to partial wear, and the second block separated in the tire circumferential direction has many edges that improve the traction performance. In the front tire, the first block is located on the outer side of the vehicle and the second block is located on the inner side of the vehicle, achieving compatibility between excellent traction performance and resistance to partial wear. Furthermore, the tread pattern on the outer side of the vehicle has a significant impact on the aerodynamic performance. The rib-shaped first block is advantageous for the aerodynamic performance as well. According to the pneumatic tire 1, the aerodynamic performance is more effectively improved by the synergistic effect of the improved shape of the tire side surface and the first block on the outer side of the vehicle.

In the example of FIG. 2, two of the pneumatic tires 1 are mounted as rear tires on each of the left and right sides of the vehicle 100. Such an arrangement is referred to as dual tires. In the case of dual tires, the tire on the inside of the vehicle is mounted such that the region R1 of the tread 10 is located on the outside of the vehicle, and the tire on the outside of the vehicle is mounted such that the region R2 of the tread 10 is located on the outside of the vehicle. In other words, also when used as a rear tire, the pneumatic tire 1 is preferably mounted in a specified orientation with respect to the vehicle 100. In this case, compatibility between the traction performance and the resistance to partial wear can be more effectively achieved.

The vehicle 100 is a large-sized vehicle such as a truck or a bus, and the pneumatic tire 1 is suitable for a heavy loading tire. Alternatively, the vehicle 100 may be an electric vehicle (EV) that is not equipped with an engine. Compared to engine-powered vehicles, EVs have features such as lower noise during driving, a heavier vehicle weight, and superior acceleration performance. Thus, tires for EVs are required to have particularly excellent quietness and wear resistance. As described above, the pneumatic tire 1 has excellent quietness and wear resistance and thus is suitable for an EV tire. Moreover, the pneumatic tires 1 has low air resistance and thus contributes to improvement in the fuel efficiency (power efficiency) of the vehicle 100. For example, the pneumatic tire 1 is suitable for a large-sized EV tire.

Hereinafter, the configuration of the pneumatic tire 1 will be described with reference to an example in which the pneumatic tire 1 is applied to a front tire and is mounted such that the region R1 of the tread 10 is located on the outside of the vehicle and the region R2 of the tread 10 is located on the inside of the vehicle.

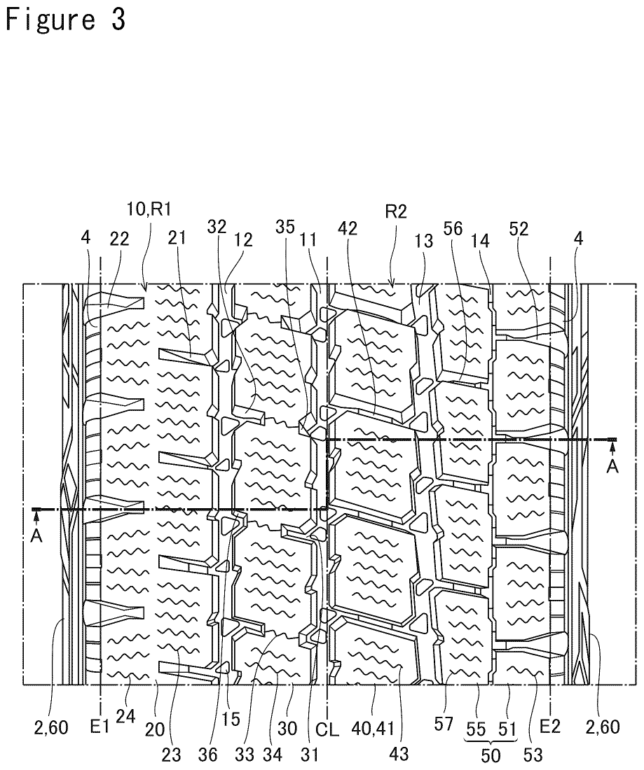

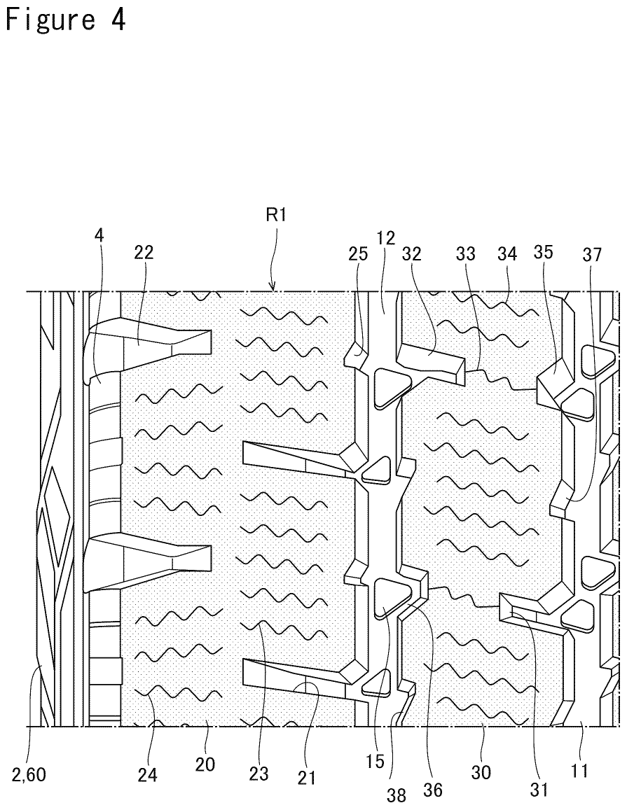

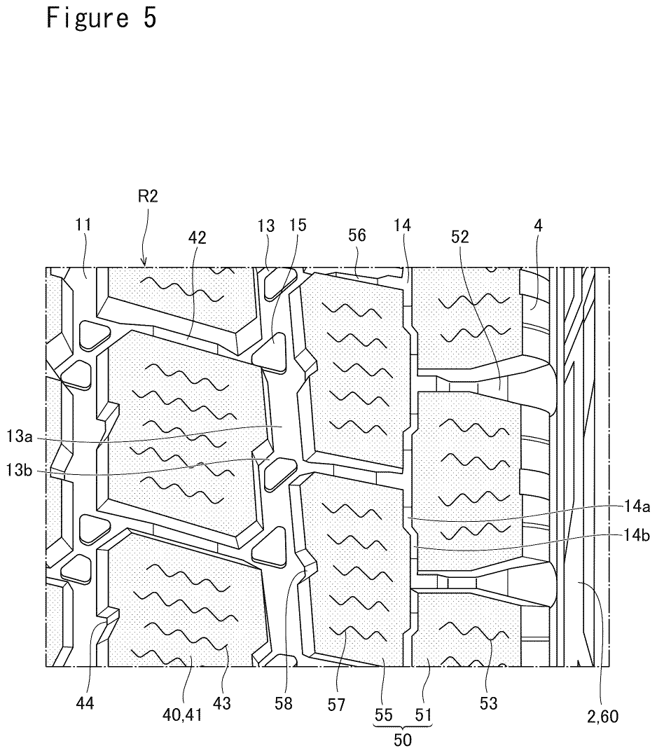

Referring to FIGS. 3 to 5, the tread pattern of the pneumatic tire 1 will be described in detail. FIG. 3 is a plan view illustrating the pneumatic tire 1. FIG. 4 is an enlarged view of the region R1 of the tread 10. FIG. 5 is an enlarged view of the region R2 of the tread 10.

As shown in FIGS. 3 to 5, as tire circumferential grooves, the tread 10 has the three main grooves 11, 12, and 13 and one narrow groove 14 having a smaller width than the main grooves. All the tire circumferential grooves are continuously formed in annular shapes in the tire circumferential direction. The main grooves 11 and 12 extend linearly along the tire circumferential direction, whereas the main groove 13 and the narrow groove 14 have a plurality of bent portions and are formed in zigzag patterns. The main groove 13 and the narrow groove 14 form irregularities on the block ends facing the grooves, increasing edges to be caught on a road surface.

The main groove 13 includes a first portion 13a and a second portion 13b (see FIG. 5) that tilt in different orientations with respect to the tire circumferential direction. The first portion 13a and the second portion 13b are alternately repeated to extend in the tire circumferential direction. The main groove 13 is drastically bent at the boundary between the first portion 13a and the second portion 13b. The inclination of the second portion 13b with respect to the tire circumferential direction is larger than that of the first portion 13a, and the length of the second portion 13b is shorter than that of the first portion 13a. The second portion 13b forms a recess, which faces the main groove 13, on the block end of the second center block 41 to increase the edges.

The narrow groove 14 includes a first portion 14a that is a projection near the equator CL and a second portion 14b that is a projection near the contact end E1 (see FIG. 5). The first portion 14a and the second portion 14b are alternately repeated in the tire circumferential direction to extend in the tire circumferential direction. The linearly extending main grooves 11 and 12 are formed in the region R1 on the outside of the vehicle, and the main groove 13 and the narrow groove 14 that extend in a zigzag pattern are formed in the region R2 on the inside of the vehicle, thereby more effectively improving the traction performance while securing resistance to partial wear. Moreover, with this configuration, an airflow is less likely to be disturbed in the region R1 on the outside of the vehicle, thereby improving the aerodynamic performance.

Although the main grooves 11, 12, and 13 may have the same width, in the present embodiment, the width of the main groove 11 located on the equator CL and the width of the main groove 13 located in the region R2 on the inside of the vehicle are slightly larger than that of the main groove 12 located in the region R1 on the outside of the vehicle. The main grooves 11 and 13 have, for example, substantially the same width, which is 1.03 times to 1.05 times that of the main groove 12. For example, the main grooves 11 and 13 are 9 mm to 11 mm in width. The width of the narrow groove 14 is, for example, 1.3 mm to 3.0 mm and is preferably 1.3 mm to 2.0 mm. In the present specification, the width of the groove means a groove width along the contact surface of the tread 10; that is, a groove width in a groove opening portion.

The depths of the main grooves 11, 12, and 13 may be different from one another, but in the present embodiment, the depths are substantially the same. At the groove bottoms of the main grooves 11, 12, and 13, stone ejectors 15 are provided as protrusions for suppressing pinching of stones. In a portion where the stone ejectors 15 are not provided, the main grooves have a uniform depth along the tire circumferential direction. Likewise, the widths of the main grooves are substantially uniform along the tire circumferential direction. The depth of the narrow groove 14 is smaller than that of the main grooves and changes in the tire circumferential direction. For example, at the deepest portion, the depth of the narrow groove 14 is 30% to 60% of the depth of the main grooves.

As described above, the plurality of horizontal grooves are formed on the tread 10. In the region R1 of the tread 10, the horizontal grooves 21, 22, 31, and 32 terminated in the first block are formed, but no horizontal grooves dividing the first block are formed. In contrast, in the region R2 of the tread 10, the horizontal grooves 42, 52, and 56 dividing the block in the tire circumferential direction are formed. The horizontal groove 42 connects the two main grooves 11 and 13 and separates the adjacent second center blocks 41 in the tire circumferential direction. The horizontal groove 52 extends from the narrow groove 14 to the shoulder 4 to separate the adjacent outer shoulder blocks 51 in the tire circumferential direction, and the horizontal groove 56 connects the main groove 13 and the narrow groove 14 to separate the adjacent inner shoulder blocks 55 in the tire circumferential direction.

In each of the blocks of the tread 10, a plurality of sipes are formed. In the present specification, a narrow groove having a width smaller than 1.2 mm is defined as a sipe. The maximum width of a sipe is preferably 0.1 mm to 1.0 mm and more preferably 0.2 mm to 0.6 mm. For example, the depth of a sipe is 30% to 60% of the depth of the main grooves. A sipe forms an edge to scratch snow ice, exhibits a drainage effect by capillary action, and improves the traction performance particularly on a snow ice road surface. In the plan view of the tread 10, each sipe extends in the tire axial direction and is formed like a wave with irregularities in the tire circumferential direction. The wavy sipe can efficiently increase edges.

The region R1 of the tread 10 includes, as the rib-shaped first block continuously extending in the tire circumferential direction, the first shoulder block 20, and the first center block 30 disposed closer to the equator CL than the first shoulder block 20. The first shoulder block 20 and the first center block 30 are separated from each other by the main groove 12 extending linearly and are continuously formed like ribs in the tire circumferential direction. In the region R1 on the outside of the vehicle, the block is prone to partial wear due to the influence of a lateral force generated during turning. However, since the rib-shaped first block is disposed in the region R1, the resistance to partial wear is remarkably enhanced and the aerodynamic performance is also improved. In the rib-shaped first block, the rigidity of the block is high and a load applied during turning can be dispersed in the tire circumferential direction. This hardly generates partial wear.

In the first shoulder block 20, the plurality of horizontal grooves 21 extending from the main groove 12 and the plurality of horizontal grooves 22 extending from the shoulder 4 are alternately formed in the tire circumferential direction. The horizontal grooves 21 and 22 are placed in a staggered pattern in the tire circumferential direction. The horizontal groove 22 is located at or near the midpoint position between two horizontal grooves 21. The horizontal grooves 21 and 22 are all terminated in the block and are formed with a length that does not reach the center of the contact surface of the first shoulder block 20 in the width direction. With this configuration, the rigidity of the block is improved and the effect of suppressing partial wear is further enhanced. For example, the spacing between the horizontal grooves 21 is slightly smaller than the width of the first shoulder block 20 (the same applies to the horizontal grooves 22).

The horizontal grooves 21 and 22 are preferably formed with lengths that do not overlap each other in the tire circumferential direction. In this case, a region where no horizontal grooves are present is formed along the tire circumferential direction in the central portion of the first shoulder block 20 in the width direction. For example, the lengths of the horizontal grooves 21 and 22 in the tire axial direction are 30% to less than 50% of the width of the first shoulder block 20. Note that the block width of the tread 10 means, unless otherwise specified, the width of the contact surface of the block along the tire axial direction in a portion where horizontal grooves or the like are not present. The first shoulder block 20 has substantially a uniform width along the tire circumferential direction.

The horizontal groove 21 tilts at an angle of, for example, 5° to 15° with respect to the tire axial direction and extends substantially parallel to the horizontal groove 56 of the inner shoulder block 55. The depth of the horizontal groove 21 decreases from the main groove 12 toward the terminal end in the block. The depth is uniform in a region in the intermediate portion of the horizontal groove 21. The horizontal groove 22 extends substantially parallel to the tire axial direction and gradually increases in width from the vicinity of the terminal end in the block toward the contact end E1. The depth of the horizontal groove 22 decreases from the contact end E1 toward the terminal end in the block. The depth is uniform in a region in the intermediate portion of the horizontal groove 22.

In the first shoulder block 20, a plurality of sipes 23 arranged with the horizontal grooves 21 in the tire circumferential direction are formed and a plurality of sipes 24 arranged with the horizontal grooves 22 in the tire circumferential direction are formed. The sipes 23 and 24 are formed with a length that does not reach the main groove 12 and the contact end E1, and both ends of the sipes 23 and 24 in the lengthwise direction are located in the block. In addition, the sipes 23 and 24 are preferably formed with lengths that do not overlap each other in the tire circumferential direction. In the present embodiment, a region where any horizontal grooves or sipes are not present is formed along the tire circumferential direction in the central portion of the first shoulder block 20 in the width direction. With this configuration, the rigidity of the block is improved and the effect of suppressing partial wear is further enhanced.

The sipes 23 and 24 are formed between two horizontal grooves. In the present embodiment, the five sipes 23 are formed at certain intervals in the tire circumferential direction between two horizontal grooves 21. The sipes 23 extend in the same direction as the horizontal groove 21 and have the same length. Between two horizontal grooves 22, the four sipes 24 having the same length are formed. The first shoulder block 20 further includes notches 25 (see FIG. 4) on the block end facing the main groove 12. In the present specification, the notch means a portion recessed in the tire axial direction or a short groove. The notch 25 is located at or near the midpoint position between two horizontal grooves 21.

In the first center block 30, a plurality of horizontal grooves 31 extending from the main groove 11 and a plurality of horizontal grooves 32 extending from the main groove 12 are alternately formed in the tire circumferential direction. The horizontal grooves 31 and 32 are placed in a staggered pattern in the tire circumferential direction. The horizontal groove 32 is located at or near the midpoint position between two horizontal grooves 31. The horizontal grooves 31 and 32 are all terminated in the block and are formed with lengths that do not overlap each other in the tire circumferential direction. For example, the lengths of the horizontal grooves 31 and 32 in the tire axial direction are 25% to 45% of the width of the first center block 30. The first center block 30 has substantially a uniform width along the tire circumferential direction. In the central portion of the second center block group 40 in the width direction, a region where no horizontal grooves are present is formed along the tire circumferential direction. With this configuration, the rigidity of the block is improved and the effect of suppressing partial wear is further enhanced.

The horizontal grooves 31 and 32 tilt at an angle of, for example, 10° to 20° with respect to the tire axial direction and extend substantially parallel to the horizontal grooves 42 of the second center block group 40. The depths of the horizontal grooves 31 and 32 decrease from the main grooves toward the terminal ends in the block. The depths are uniform in regions in the intermediate portions of the horizontal grooves 31 and 32. Furthermore, on the extension of the horizontal groove 31, a notch 36 shorter than the horizontal groove 31 in the tire axial direction is formed. On the extension of the horizontal groove 32, a notch 35 shorter than the horizontal groove 32 in the tire axial direction is formed. In the first center block 30, the horizontal grooves 31 and the notches are alternately disposed in the tire circumferential direction near the main groove 11, and the horizontal grooves 32 and the notches 36 are alternately disposed in the tire circumferential direction near the main groove 12.

The first center block 30 is considerably constricted in a portion between the horizontal groove 31 and the notch 36 and a portion between the horizontal groove 32 and the notch 35. Such constricted portions are formed at predetermined intervals in the tire circumferential direction, thereby improving the traction performance. The first center block 30 further includes notches 37 and 38 (see FIG. 4) smaller than the notches 35 and 36 on the block ends facing the main grooves 11 and 12. The notch 37 is located at or near the midpoint position between the horizontal groove 31 and the notch 35, and the notch 38 is located at or near the midpoint position between the horizontal groove 32 and the notch 36.

In the present embodiment, the spacing between the horizontal groove 32 and the notch 36; that is, the spacing between the constricted portions is substantially equal to the spacing between the horizontal grooves 21 of the first shoulder block 20. The horizontal groove 32 or the notch 36 and the notch 25 of the first shoulder block 20 are opposed to each other in the tire axial direction. Moreover, the notch 38 and the horizontal groove 21 are opposed to each other in the tire axial direction. In this case, mud, sand, and snow or the like is prone to be caught into the grooves, thereby improving the traction performance. Meanwhile, the horizontal grooves 32 or the notches 36 and the horizontal grooves 21 are placed in a staggered pattern without being arranged in the tire axial direction. This secures the rigidity of the first block to suppress partial wear.

In the first center block 30, sipes 33 and 34 extending in the same direction as the horizontal grooves 31 and 32 are formed. The sipe 33 is formed in a constricted portion between the horizontal groove 31 and the notch 36 and in a constricted portion between the horizontal groove 32 and the notch 35. In other words, the sipe 33 crosses the block at the constricted portion, but no horizontal grooves divide the first center block 30. Portions located on both sides of the sipe 33 in the tire axial direction can support each other when the sipe 33 is closed by a load. Thus, this configuration can improve the traction performance while securing the rigidity of the block.

The sipe 34 is formed with a length that does not reach the main grooves 11 and 12, and both ends of the sipe 34 in the lengthwise direction are located in the block. In the present embodiment, the plurality of (five) sipes 34 are formed at certain intervals in the tire circumferential direction between the two horizontal grooves 31 and 32. The sipes 34 include two kinds of sipes having different lengths. The two kinds of sipes are alternately disposed in the tire circumferential direction. For example, the length of the first sipe, which is longer, in the tire axial direction is 50% to 80% of the width of the block. The second sipe preferably has a shorter length that is 50% to 90% of the length of the first sipe. With this configuration, the traction performance can be improved while securing the rigidity of the block. Furthermore, a uniform contact pressure can be obtained, further enhancing the effect of suppressing partial wear.

The region R2 of the tread 10 includes the second center block group 40 and the second shoulder block group 50 as columns of the plurality of second blocks separated in the tire circumferential direction. The second center block group 40 and the second shoulder block group 50 are separated by the main groove 13 extending in a zigzag pattern. The second center blocks 41, the outer shoulder blocks 51, and the inner shoulder blocks 55 that constitute the block groups are each formed in plurality in the tire circumferential direction. The columns of the blocks separated in the tire circumferential direction are placed in the region R2 on the inside of the vehicle, thereby remarkably improving the traction performance.

The second center block group 40 is configured such that the second center blocks 41 are arranged in a line in the tire circumferential direction. The second center blocks 41 are separated by the horizontal grooves 42, and the second center blocks 41 and the horizontal grooves 42 are alternately disposed in the tire circumferential direction. The second shoulder block group 50 is composed of two columns of blocks arranged in the tire circumferential direction. The two columns of blocks constituting the second shoulder block group 50 include the plurality of outer shoulder blocks 51 and the plurality of inner shoulder blocks 55, respectively. The outer shoulder blocks 51 are separated by the horizontal grooves 52, and the outer shoulder blocks 51 and the horizontal grooves 52 are alternately disposed in the tire circumferential direction. Moreover, the inner shoulder blocks 55 are separated by the horizontal grooves 56, and the inner shoulder blocks 55 and the horizontal grooves 56 are alternately disposed in the tire circumferential direction.

The second center block 41 is formed wider than the first center block 30. The width of the second center block 41 slightly changes along the tire circumferential direction. The maximum value and the mean value of the width is, for example, 1.03 times to 1.10 times the width of the first center block 30. Since the rib-shaped first block is disposed in the region R1 of the tread 10, the volume of rubber is prone to increase in the region R1. A difference in the volume of rubber between the regions R1 and R2 can be reduced by forming the wide second center block 41. Consequently, the effect of suppressing partial wear is further enhanced. Moreover, in the central region of the tread with a high contact pressure, the traction performance is further improved by forming the wide second block.

The horizontal groove 42 tilts at an angle of, for example, 10° to 20° with respect to the tire axial direction, and the horizontal groove 56 tilts at a smaller angle than that of the horizontal groove 42 with respect to the tire axial direction. The horizontal groove 52 extends substantially parallel to the tire axial direction and gradually increases in width from the intermediate portion between the narrow groove 14 and the contact end E2 toward the contact end E2. The horizontal groove 42 is displaced in the tire circumferential direction to avoid overlapping the horizontal groove 31 and the notch 35 of the first center block 30 in the tire axial direction. In this case, the traction performance can be improved while securing the rigidity of the block in the central region of the tread 10. Furthermore, a notch 44 (see FIG. 5) is formed on the block end of the second center block 41, facing the main groove 11.

The horizontal grooves 42 and 56 are placed in a staggered pattern in the tire circumferential direction. The horizontal groove 42 is located at or near the midpoint position between two horizontal grooves 56. Likewise, the horizontal grooves 52 and 56 are placed in a staggered pattern in the tire circumferential direction. The horizontal groove 52 is located at or near the midpoint position between two horizontal grooves 56. In this case, the traction performance can be improved while securing the rigidity of the block. Furthermore, a notch 58 is formed at a position opposed to the horizontal groove 42 in the tire axial direction on the block end of the inner shoulder block 55, facing the main groove 13.

The depths of the horizontal grooves 42, 52, and 56 may be uniform along the overall lengths and may be equal to the depth of the main groove. In the present embodiment, the horizontal grooves have smaller depths than the main groove. The horizontal groove 42 gradually decreases in depth from both ends toward the central portion in the lengthwise direction, and the depth is substantially uniform in a predetermined length range including the central portion in the lengthwise direction. Furthermore, the horizontal grooves 52 and 56 decrease in depth toward the narrow groove 14. Like the horizontal groove 42, the depth is substantially uniform in a predetermined length range including the central portion in the lengthwise direction. The depth of the narrow groove 14 changes in the tire circumferential direction. The depth decreases at or near the points of intersection with the horizontal grooves 52 and 56, and increases at a location remote from the points of intersection. By setting the depths of the horizontal grooves and the narrow groove 14 in this manner, the traction performance can be improved while securing the rigidity of the block.

In the second center block group 40, a plurality of sipes 43 extending in the same direction as the horizontal groove 42 are formed and arranged in the tire circumferential direction. The sipe 43 is formed with a length that does not reach the main grooves 11 and 13, and both ends of the sipe 43 in the lengthwise direction are located in the block. The sipes 43 include two kinds of sipes having different lengths. The two kinds of sipes are alternately disposed in the tire circumferential direction. For example, the length of the first sipe, which is longer, in the tire axial direction is 50% to 80% of the maximum width of the block. The second sipe preferably has a shorter length that is 50% to 90% of the length of the first sipe. With this configuration, the traction performance can be improved while securing the rigidity of the block. Furthermore, a uniform contact pressure can be obtained, further enhancing the effect of suppressing partial wear.

In the outer shoulder block 51 and the inner shoulder block 55, a plurality of sipes 53 and 57 are formed at certain intervals in the tire circumferential direction. The sipes 53 and 57 are all formed with a length that does not reach the block end, and have both ends located in the contact surface of the block. The sipes 57 extend in the same direction as the horizontal groove 56 and have the same length. Likewise, the sipes 53 have the same length, but the number of sipes 53 is smaller than that of sipes 57. Also in the first shoulder block 20, the number of sipes 24 between the horizontal grooves 22 is smaller than that of the sipes 23 between the horizontal grooves 21. The number of sipes is reduced near the contact ends E1 and E2, which are easily affected by a lateral force during turning. This configuration can secure the rigidity of the block and effectively suppress partial wear.

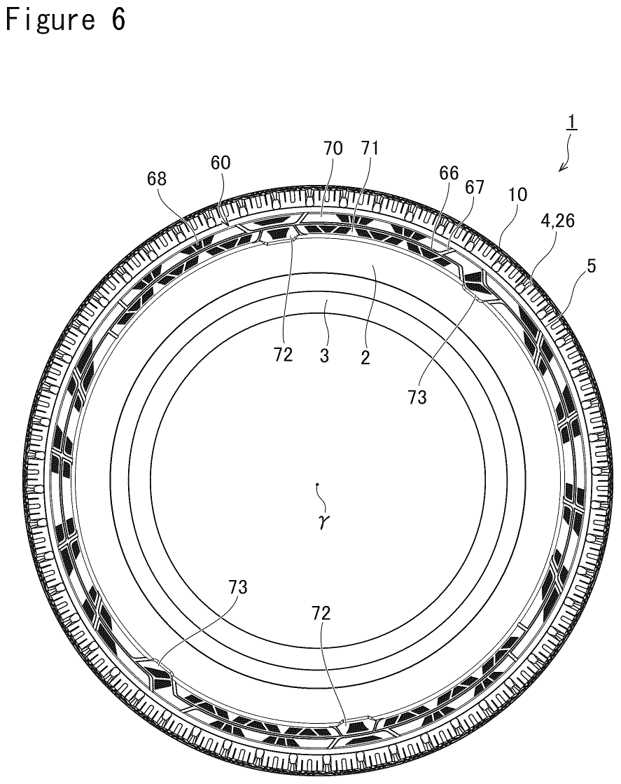

Referring to FIGS. 6 to 11, the side surface shape of the pneumatic tire 1, in particular, a side surface shape from the shoulder 4 to the tire maximum width position P of the side wall 2, will be described in detail.

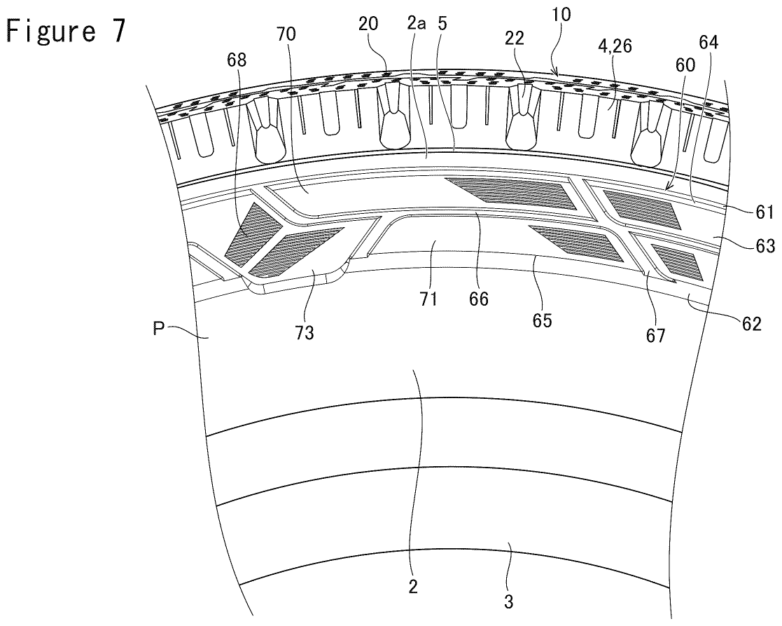

FIG. 6 is a side view of the pneumatic tire 1. FIG. 7 is an enlarged view of a part of a tire side surface. As shown in FIGS. 6 and 7, the side wall 2 includes the side protector 60 that is formed in an annular shape in side view. As described above, the side protector 60 is an annular projection that protrudes outward in the tire axial direction. The side protector 60 is formed between the side rib 5 and the tire maximum width position P (see FIG. 7) and improves the side-cut resistance of the side wall 2. The side protector 60 is formed with a substantially uniform width along the tire circumferential direction with respect to a rotation axis y (see FIG. 6) of the pneumatic tire 1. In addition, the side protector 60 is formed with a clearance between the side protector 60 and the side rib 5 and has a width that does not reach the tire maximum width position P.

The length of the side protector 60 in the tire radial direction is preferably equal to or greater than 50% of a length from the side rib 5 to the tire maximum width position P. In the present embodiment, the length is 60% to 90%. In this case, damage to the side wall 2 can be more effectively suppressed. Generally, a side protector increases air resistance. According to the pneumatic tire 1, the surface shape of the shoulder 4 is improved. This can generate a smooth airflow along the tire side surface including the side protector 60, thereby achieving excellent aerodynamic performance.

As will be specifically described later, the side protector 60 includes a first end face 61 located on the outer end in the tire radial direction, a second end face 62 located on the inner end in the tire radial direction, and a principal surface 63 connecting the first end face 61 and the second end face 62. A first boundary portion between the first end face 61 and the principal surface 63 is curved to project outward in the tire axial direction. Meanwhile, a second boundary portion between the second end face 62 and the principal surface 63 is more angular than the first boundary portion. A curved surface 64 formed at the first boundary portion between the first end face 61 and the principal surface 63 more effectively improves the aerodynamic performance of the pneumatic tire 1 due to the synergistic effect with the surface shape of the shoulder 4.

In view of improvement in design and aerodynamic performance, the side protector 60 has a circumferential groove 66 extending in the tire circumferential direction and a radial groove 67 extending in the tire radial direction. The depths of the circumferential groove 66 and the radial groove 67 are preferably smaller than the height of the side protector 60, and portions where the grooves are formed also protrude from the profile surface α. The side protector 60 is divided into a plurality of blocks by the circumferential groove 66 and the radial groove 67. The circumferential groove 66 and the radial groove 67 have the same depth. For example, the depth is 0.3 mm to 0.6 mm. For example, the circumferential groove 66 has a width of 2 mm to 4 mm and the radial groove 67 has a width of 3 mm to 5 mm.

The circumferential groove 66 is formed in the central portion of the side protector 60 in the width direction and divides the side protector 60 into an outer block 70 and an inner block 71. The outer block 70 is located outside the circumferential groove 66 in the tire radial direction, and the inner block 71 is located inside the circumferential groove 66 in the tire radial direction. The radial groove 67 is formed from the circumferential groove 66 to the first end face 61 and divides the outer block 70 into a plurality of blocks arranged in the tire circumferential direction. Moreover, the radial groove 67 is formed from the circumferential groove 66 to the second end face 62 and divides the inner block 71 into a plurality of blocks arranged in the tire circumferential direction.

The circumferential groove 66 and the radial groove 67 contribute to improvement in aerodynamic performance along with the serration 68. As described above, the serration 68 is a fine relief structure extending in the tire circumferential direction and includes a plurality of protrusions and grooves in the tire circumferential direction. The plurality of protrusions are formed with a height that does not protrude from the principal surface 63 of the side protector 60. The serration 68 has the function of rectifying air in contact with the side protector 60 in the tire rotation direction. At least one serration 68 is formed in each of the blocks separated by the circumferential groove 66 and the radial groove 67. The total formation area of the serration 68 is larger in the inner block 71, which protrudes far to the outside in the tire axial direction, than in the outer block 70.

The side protector 60 includes a plurality of blocks 73 that are formed from the first end face 61 to the second end face 62 while dividing the circumferential groove 66. The blocks 73 are arranged in the tire radial direction with the rotation axis y interposed therebetween in a side view of the tire. In the present embodiment, the block 73 is disposed at each central angle of 180° with respect to the rotation axis y. The circumferential groove 66 is divided into semicircles by the two blocks 73. The block 73 includes an outer region arranged with the outer block 70 in the tire circumferential direction and an inner region arranged with the inner block 71 in the tire circumferential direction. The block 73 has a bent shape such that the outer region overlaps the inner block 71 in the tire radial direction and the inner region overlaps the outer block 70 in the tire radial direction.

The outer block 70 is a gradually curved rectangular block in side view and includes a plurality of blocks having different lengths in the tire circumferential direction and different end shapes in the tire circumferential direction. On the outside of the side protector 60 in the tire radial direction, the outer blocks 70 are arranged in a row in the tire circumferential direction. Furthermore, the outer blocks 70 have a similar block pattern in each of semicircles separated by the blocks 73. In the present embodiment, eight outer blocks 70 are disposed between the two blocks 73.

Like the outer block 70, the inner block 71 is a gradually curved rectangular block in side view and includes a plurality of blocks having different lengths in the tire circumferential direction and different end shapes in the tire circumferential direction. On the inside of the side protector 60 in the tire radial direction, the inner blocks 71 are arranged in a row in the tire circumferential direction. Furthermore, the inner blocks 71 have a similar block pattern in each of the semicircles separated by the blocks 73. In the present embodiment, eight inner blocks 71, equal in number with the outer blocks 70, are disposed between the two blocks 73.

The inner block 71 includes a plurality of inner small blocks 72 that protrude inward from other blocks in the tire radial direction. The inner small blocks 72 are arranged in the tire radial direction with the rotation axis y interposed therebetween in a side view of the tire. In the present embodiment, the inner small block 72 is disposed in each of the semicircles. The blocks 73 also protrude inward from the other inner blocks 71 in the tire radial direction. Thus, the width of the side protector 60 increases locally in a portion where the inner small block 72 and the block 73 are disposed. Meanwhile, on the outside of the side protector 60 in the tire radial direction, such a locally protruding shape is not present and thus an airflow coming into contact with the side protector 60 is hardly disturbed.

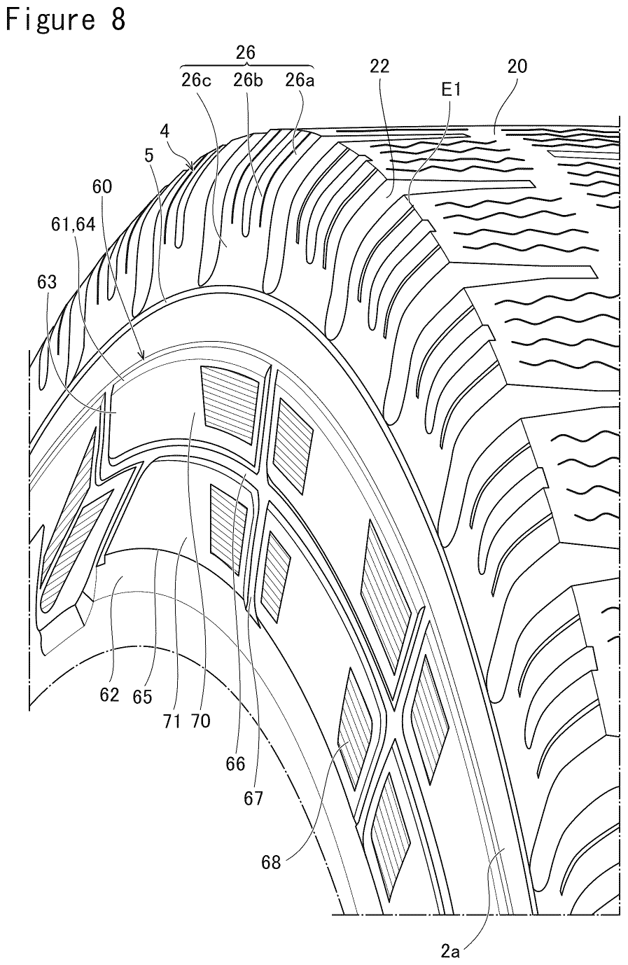

FIG. 8 is a perspective view showing the shoulder 4 and the vicinity thereof. As shown in FIG. 8, the surface of the shoulder 4 near the contact end E1 on the outside of the vehicle is formed by a side surface of the first shoulder block 20, the side surface being oriented to the outside in the tire axial direction. Moreover, the surface of the shoulder 4 near the contact end E2 on the inside of the vehicle is formed by a side surface of the outer shoulder block 51, the side surface being oriented to the outside in the tire axial direction. The side surfaces of the first shoulder block 20 and the outer shoulder block 51 have identical shapes, and thus the surfaces of the left and right shoulders 4 have identical shapes. The first shoulder block 20 is a rib-shaped block extending continuously in the tire circumferential direction, whereas the outer shoulder block 51 is divided by the horizontal groove 52.

The aerodynamic performance of the front tires is easily affected by the tread pattern located on the outside of the vehicle and the shape of the tire side surface. According to the pneumatic tire 1, the region R1 of the tread 10 including the first shoulder block 20 is disposed on the outside of the vehicle. This can generate a smooth airflow along the tire surface from the tread 10 to the shoulder 4 and the side wall 2. Furthermore, the main groove 12 linearly formed in the region R1 and the rib-shaped first center block 30 also contribute to improvement in aerodynamic performance. An example of the shoulder 4 on the outside of the vehicle will be described below to specifically illustrate the configuration of the shoulder 4.

As described above, the shoulder 4 has a shoulder surface 26 in an arc shape where a corner is substantially absent. As disclosed in JP 2020-1617 A, a conventional heavy loading tire has an angular contact end shape to extend the contact surface of the tread, and the shoulder also has an angular shape. Conventionally, aerodynamic performance has been hardly examined for heavy loading tires. However, particularly in EVs, noise generated from tires is likely to be annoying and power efficiency is also prioritized. Thus, it is important to improve the aerodynamic performance of tires. As a result of diligent examination under such circumstances, the inventor found that an angular shoulder shape considerably affects the aerodynamic performance of tires, and the shoulder surface 26 in an arc shape remarkably improves aerodynamic performance.

The shoulder surface 26 is a surface that connects the contact end E1 and the side rib 5 and is curved to project outward in the tire axial direction. Moreover, the shoulder surface 26 protrudes so as to be gradually located outward in the tire axial direction from the contact end E1 to the inside in the tire radial direction. In this case, the contact area increases in mud, sand, and on a snowy road or the like, thereby improving the traction performance. The overall shoulder surface 26 may be shaped like an arc. In view of improvement in traction performance and design, a part of the shoulder surface 26 is preferably curved to project outward in the tire axial direction.

The shoulder surface 26 preferably has an arc-shaped curved surface 26b that projects outward in the tire axial direction, at a position remote from the contact end E1 and the side rib 5. In the present embodiment, only a part of the shoulder surface 26 is curved to project in the tire axial direction. Furthermore, a region from the contact end E1 to the curved surface 26b is flat, and a region from the curved surface 26b to the side rib 5 is curved to project inward in the tire axial direction; that is, in a direction opposite from the curved surface 26b. The shoulder surface 26 has a flat surface 26a, the curved surface 26b, and a second curved surface 26c sequentially from the contact end E1. With this configuration, the aerodynamic performance can be effectively improved while properly securing traction performance and design.

In the present embodiment, a corner is formed at the boundary between an outward-facing surface of the first shoulder block 20 in the tire radial direction and an outward-facing surface of the first shoulder block 20 in the tire axial direction. The corner serves as the contact end E1. The angular contact end E1 is disadvantageous to the aerodynamic performance. However, the corner is chamfered and the contact end is moved inward in the tire axial direction, so that the contact surface of the tread 10 is downsized and deteriorates the traction performance. The pneumatic tire 1 has the shoulder surface 26 including the curved surface 26b, thereby reducing the influence of the angular contact end E1 and achieving a smooth airflow along the side surface of the tire.

On the shoulder 4, the horizontal grooves 22 are formed from the inside of the contact end E1 in the tire axial direction to the side rib 5. The horizontal grooves 22 form portions recessed inward in the tire axial direction on the shoulder 4. Although the presence of the horizontal grooves 22 is slightly disadvantageous to a smooth airflow, the horizontal grooves 22 are short grooves terminated in the first shoulder block 20 and do not considerably affect the aerodynamic performance of the pneumatic tire 1.

On the side wall 2, an annular region 2a recessed from the side rib 5 and the side protector 60 is formed between the side rib 5 and the side protector 60. The surface of the region 2a may have the same height as the profile surface α. The first end face 61 located on the outer end of the side protector 60 in the tire radial direction is a surface connecting the region 2a as a recessed portion and the principal surface 63 of the side protector 60 as a projection. A portion near the region 2a is gradually curved to project inward in the tire axial direction (particularly see FIG. 9 described later). Meanwhile, a portion near the principal surface 63 is curved to project outward in the tire axial direction. With this configuration, a smooth airflow can be achieved along the surface of the side protector 60.

At the first boundary portion between the first end face 61 and the principal surface 63, a curved surface 64 is formed to project outward in the tire axial direction. The curved surface 64 is formed along the tire circumferential direction in a portion except for the opening portion of the radial groove 67. A corner may be formed at the opening portion of the radial groove 67. Since the height of the side protector 60 is low at the opening portion of the radial groove 67 and the formation range of the opening portion is small, the impact of the corner on the aerodynamic performance is small. At the boundary portion between the first end face 61 and the principal surface 63, the curved surface 64 is formed in an arc shape where a corner is substantially absent, except for the opening portion of the radial groove 67.

The second end face 62 located on the inner end of the side protector 60 in the tire radial direction is a curved surface projecting inward like a portion near the region 2a of the first end face 61. The degree of curvature is larger than that of the first end face 61. Furthermore, at the first boundary portion between the second end face 62 and the principal surface 63, a corner 65 is formed. The corner 65 emphasizes the edge of the side protector 60 and improves the design. The second boundary portion is less likely to affect the aerodynamic performance than the first boundary portion. Thus, the corner 65 is preferably formed in consideration of the design.

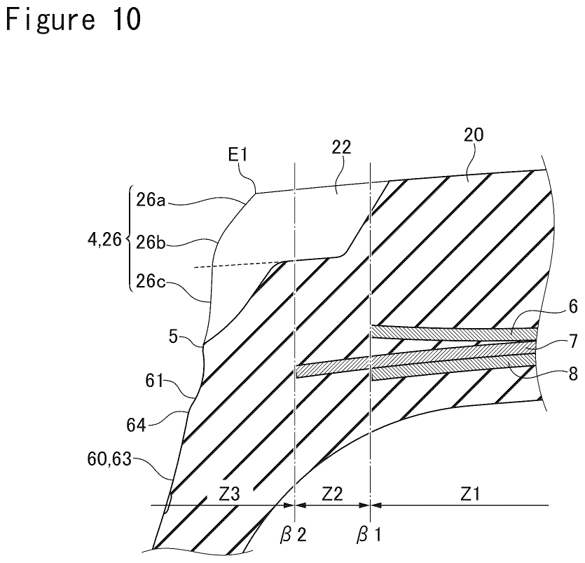

FIG. 9 shows a part of a cross section taken along line AA of FIG. 3. FIG. 10 is an enlarged view of the shoulder 4 and the vicinity thereof near the contact end E1 of FIG. 9. As shown in FIGS. 9 and 10, the pneumatic tire 1 includes three belts 6, 7, and 8. Although the number of belts may be one, two, or four or more, the preferable number of belts is three. The belts 6, 7, and 8 are stacked in this order from the outside in the tire radial direction and increase the rigidity of the tread 10 to suppress partial wear of the block. In the present embodiment, the belts 6 and 8 have the same width. The belt 7 interposed between the belts 6 and 8 is wider than the belts 6 and 8 and protrudes to both ends in the tire axial direction from the ends of the belts 6 and 8 (hereinafter simply referred to as “belt ends”) in the tire axial direction.

The pneumatic tire 1 has a first region Z1 in which the belts 6, 7, and 8 overlap one another in the tire radial direction, a second region Z2 that is located outside the first region Z1 in the tire axial direction and contains a portion of the belt 7, and a third region Z3 that is located outside the second region Z2 in the tire axial direction and contains no belts. FIG. 9 shows a virtual line β1 passing through the belt ends of the belts 6 and 8 along the tire radial direction, and a virtual line β2 passing through the belt end of the belt 7 along the tire radial direction. The first region Z1 is a region located inside the virtual line β1 in the tire axial direction, the second region Z2 is a region located between the virtual lines β1 and β2, and the third region Z3 is a region located outside the virtual line β2 in the tire axial direction.

The first region Z1 increases the rigidity of the tread 10 from the center to shoulders and reduces the partial wear of the block. The third region Z3 having lower rigidity than the first region Z1 and the second region Z2 is set slightly inside the contact ends E1 and E2 in the tire axial direction. If the shoulders 4, which are easily affected by a lateral force, have high rigidity, the shoulders 4 may be subject to a rebound that deteriorates handling when coming into contact with a rut or the like. Moreover, such a rebound may disturb an airflow. In the present embodiment, the overall shoulder 4 set as the third region Z3 can easily absorb a lateral force received by the shoulder 4. This improves handling and contributes to improvement in aerodynamic performance.

An arc shape formed to project outward in the tire axial direction on the surface of the shoulder 4 is formed in the third region Z3. Hereinafter, the shoulder 4 near the contact end E1 in FIG. 10 will be described as an example. As described above, the shoulder surface 26 has the curved surface 26b projecting outward in the tire axial direction. In the present embodiment, since the overall shoulder surface 26 is the third region Z3, the curved surface 26b is formed in the third region Z3. The shoulder surface 26 having the curved surface 26b without any corners can disperse a lateral force along the curved surface 26b. Thus, the partial wear of the block is suppressed and the airflow is less disturbed. In addition, the function of the curved surface 26b formed in the third region Z3 allows dispersion and absorption of a lateral force.

In contrast, when the shoulder surface has an angular shape, a force concentrates on the corner and partial wear is likely to occur on the block. Furthermore, the airflow is likely to be disturbed by a rebound. In addition, a smooth airflow cannot be achieved along the side surface of the tire, which may increase the air resistance and the occurrence of wind noise.

The curved surface 26b of the shoulder surface 26 is also formed on the extension of the bottom of the horizontal groove 21. As described above, the horizontal groove 22 extends from the inside of the contact end E1 in the tire axial direction to the shoulder 4 and has a substantially uniform depth in the intermediate portion of the horizontal grooves 22. In the present embodiment, the curved surface 26b is formed on the extension of the groove bottom in a region where the horizontal groove 22 has a uniform depth. With this configuration, a lateral force is easily dispersed and absorbed, thereby enhancing the effect of improving handling and aerodynamic performance.

FIG. 11 shows a part of an outline along the tire surface near the contact end E1 in the cross-sectional view of FIG. 9. In FIG. 11, the profile surface α of the side wall 2 is indicated by a chain double-dashed line. In a cross section along the tire axial direction, the profile surface α is a surface indicated by a curve smoothly connecting a first curve along the surface of the side wall 2 inside the side protector 60 in the tire radial direction and a second curve along the surface of the side wall 2 outside the side protector 60 in the tire radial direction.

As shown in FIG. 11, the shoulder surface 26 has the curved surface 26b that is curved outward in the tire axial direction with a curvature radius R26b. The shoulder surface 26 does not have a corner like the contact end E1; that is, a bent portion with a curvature radius of 0.1 mm or less. The curvature radius R26b of the curved surface 26b is set at, for example, 5 mm or more. The curvature radius R26b is preferable at 5 mm to 15 mm, more preferable at 7 mm to 13 mm, and particularly preferable at 8 mm to 12 mm. When the curvature radius R_{26b} is set within the range, a smooth airflow is easily achieved along the side surface of the tire, enhancing the effect of improving aerodynamic performance.

As described above, the shoulder surface 26 has the flat surface 26a formed between the contact end E1 and the curved surface 26b and the second curved surface 26c formed between the curved surface 26b and the side rib 5. The flat surface 26a, the curved surface 26b, and the second curved surface 26c are smoothly connected without forming corners at the boundaries. Although the overall shoulder surface 26 may be a curved surface having a curvature radius of 5 mm or more, the provision of the three surfaces can effectively improve the aerodynamic performance while properly securing traction performance and design. The curvature radius of the second curved surface 26c is, for example, 100 mm to 150 mm, which is smaller than that of the curved surface 26b.

The length of the curved surface 26b in the tire radial direction is, for example, 20% to 60% of that of the shoulder 4 in the tire radial direction. The length is preferably 30% to 50% of that of the shoulder 4. The length of the flat surface 26a in the tire radial direction is preferably shorter than that of the curved surface 26b. For example, the length is 15% to 25% of that of the shoulder 4 in the tire radial direction. The length of the second curved surface 26c in the tire radial direction may be substantially equal to that of the curved surface 26b in the tire radial direction. For example, the length is 20% to 60% of that of the shoulder 4 in the tire radial direction. When the lengths of the flat surface 26a, the curved surface 26b, and the second curved surface 26c are set within the range in the tire radial direction, the effect of the provided three surfaces is further enhanced.

The flat surface 26a preferably tilts at an angle of 30° to 50° with respect to a virtual line β3 passing through the contact end E1 along the tire radial direction. In this case, proper traction performance can be obtained without impairing aerodynamic performance. The flat surface 26a may be replaced with a curved surface having a larger curvature radius than the curved surface 26b without impairing the traction performance and the design. Moreover, the second curved surface 26c formed as a curved surface projecting inward in the tire axial direction may be replaced with a flat surface.

The side protector 60 is a projection that protrudes outward from the profile surface α in the tire axial direction. For example, a height H₆₀ of the side protector 60 is 1.0 mm to 3.5 mm at the highest portion. The height is preferably 1.0 mm to 2.0 mm. Note that the height H₆₀ means a length from the profile surface α to the side protector 60 along a direction perpendicular to the profile surface α. The principal surface 63 of the side protector 60 has the uniform height H₆₀ and is formed parallel to the profile surface α in a portion other than portions where the circumferential groove 66, the radial groove 67, and the serration 68 are formed.

The first end face 61 and the second end face 62 of the side protector 60 are surfaces connecting the profile surface α and the principal surface 63, and gradually increase in height toward the principal surface 63. In the present embodiment, the region 2a located between the side rib 5 and the side protector 60 is as high as the profile surface α. The height of the side rib 5 is, for example, 1.0 mm or less, which is lower than that of the side protector 60. The lengths of the first end face 61 and the second end face 62 in the tire radial direction are preferably two times to five times the maximum value of the height H₆₀ of the side protector 60.

At the first boundary portion between the first end face 61 and the principal surface 63 of the side protector 60, the curved surface 64 is formed to project outward in the tire axial direction. A curvature radius R₆₄ of the curved surface 64 is preferably smaller than a curvature radius R26b of the curved surface 26b of the shoulder surface 26. The aerodynamic performance is improved by forming the curved surface 64 at the first boundary portion. However, when the curvature radius R₆₄ of the curved surface 64 is excessively large, the edge of the side protector 60 becomes less visible, leading to an undesirable state of the design. The first boundary portion is less likely to affect the aerodynamic performance than the shoulder surface 26. Thus, the curved surface 64 is preferably formed with the curvature radius R₆₄<curvature radius R26b.

The curvature radius R₆₄ of the curved surface 64 is preferably 1 mm to 10 mm and more preferably 3 mm to 7 mm. When the curvature radius R₆₄ is set within the range, a smooth airflow can be achieved along the side surface of the tire without impairing the design of the side wall 2. Meanwhile, the second boundary portion between the first end face 61 and the principal surface 63 of the side protector 60 is more angular than the first boundary portion and has the corner 65. The second boundary portion is less likely to affect the aerodynamic performance than the first boundary portion. Thus, the corner 65 preferably emphasizes the edge of the side protector 60 to improve the design.

As described above, the pneumatic tire 1 configured thus has excellent aerodynamic performance and contributes to, for example, improvement in the quietness and fuel efficiency of a vehicle. The pneumatic tire 1 is suitable for heavy loading tires and is particularly suitable for EV tires (tires for large EVs) that require high quietness and fuel efficiency (power efficiency). According to the pneumatic tire 1, the improved side surface shape of the tire can generate a smooth airflow along the tire side surface including the side protector 60. This reduces the air resistance and improves the quietness.

On the pneumatic tire 1, the linear main groove 12 of the region R1 disposed on the front tire on the outside of the vehicle and the rib-shaped first block remarkably contribute to improvement in aerodynamic performance. The evaluation result of the air resistance of the pneumatic tire 1 will be described below.

### [Evaluation of Air Resistance]

For the pneumatic tire 1 having the foregoing configuration (hereinafter referred to as “test tire S1”), an air resistance is evaluated at a vehicle speed of 40 km/h according to a simulation for analyzing an airflow around the rotating tire. For comparison, instead of the curved surface 26b of the shoulder surface 26 and the curved surface 64 at the first boundary portion of the side protector 60, a test tire B1 having a corner at the corresponding position is evaluated. An air resistance is evaluated using a drag coefficient (Cd value). Table 1 shows the evaluation results of the test tires B1 and S1.

Main specifications for evaluating the air resistance of the test tire S1 are listed below.
Curvature radius R_{26b} of the curved surface 26b: 10 mm
Curvature radius R₆₄ of the curved surface 64: 5 mm
Height H₆₀ of the side protector 60: 1.2 mm
Length of the first end face 61 of the side protector 60 in tire axial direction: 2.0 mm

A drag (a force applied to the tire in an airflow and applied in the same direction as a direction parallel to the airflow) is determined from a pressure difference between the front and rear of the tire through a simulation, and then the Cd value is calculated by the equation below.

$$Cd = D / ( 1 / 2 ρ U 2 S )$$

wherein D is a generated drag, p is an air density of 1.18415 [kg/m³], U is a representative speed that is the relative speed of the tire to air, to be specific, 36.1 [m/s], and S is the representative area (front projection area) of the tire.

TABLE 1

| | R_{26b} | R₆₄ | Cd |
|---|---|---|---|
| Tire B1 | — | — | 0.615 |
| Tire S1 | 10 mm | 5 mm | 0.588 |

As shown in Table 1, the test tire S1 has a lower Cd value and higher aerodynamic performance as compared with the test tire B1. The test tire S1 can reduce the Cd value by about 4.3% compared with the test tire B1.

The foregoing embodiment can be modified in design as appropriate without departing from the scope of the present disclosure. For example, the present embodiment illustrated the tire that is suitable for winter tires having a large number of sipes. The configuration of the present disclosure is also applicable to summer tires or all-season tires having a small number of sipes. For summer tires or all-season tires, the same side surface shape of the tire is applicable as the pneumatic tire 1 and a tread pattern is applicable, in which rib-shaped blocks are consecutively arranged in the tire circumferential direction and columns of blocks are separated in the tire circumferential direction.

1. A pneumatic tire comprising:
a tread,
side walls, and
a shoulder,
the shoulder being located between a contact end of the tread and the side wall,
the pneumatic tire having a corner at the contact end,
wherein the shoulder has a shoulder surface on which a corner is substantially absent, and
the shoulder surface has an arc shape that is curved to project outward in a tire axial direction.

2. The pneumatic tire according to claim 1, wherein the arc shape of the shoulder surface has a curvature radius of 5 mm to 15 mm.

3. The pneumatic tire according to claim 1, wherein the side wall has a side protector,
the side protector includes a first end face located on an outer end in a tire radial direction, a second end face located on an inner end in the tire radial direction, and a principal surface connecting the first end face and the second end face,
a first boundary portion between the first end face and the principal surface is curved to project outward in a tire axial direction, and a second boundary portion between the second end face and the principal surface is more angular than the first boundary portion.

4. The pneumatic tire according to claim 3, wherein the first boundary portion of the side protector has a curvature radius that is smaller than a curvature radius of the arc shape of the shoulder surface.

5. The pneumatic tire according to claim 1, wherein the pneumatic tire includes a plurality of belts and has a first region in which the belts overlap one another in the tire radial direction, a second region that is located outside the first region in the tire axial direction and contains a portion of one of the belts, and a third region that is located outside the second region in the tire axial direction and contains no belts, and
the arc shape of the shoulder surface is formed in the third region.

6. The pneumatic tire according to claim 1, wherein the tread has a horizontal groove that extends from inside of the contact end in the tire axial direction to the shoulder, and
the arc shape of the shoulder surface is formed on an extension at a bottom of the horizontal groove.

7. The pneumatic tire according to claim 1, wherein the pneumatic tire is a tire mounted in a specified orientation with respect to a vehicle, and
when the pneumatic tire is mounted as a front tire to the vehicle, the tread has a rib-shaped first block that extends continuously in a tire circumferential direction in a region located on an outside of the vehicle with respect to a tire equator and columns of a plurality of second blocks separated in the tire circumferential direction in a region located on an inside of the vehicle with respect to the tire equator.

8. The pneumatic tire according to claim 7, wherein the first block includes a shoulder block that forms the shoulder and a center block disposed closer to the tire equator than the shoulder block.

9. The pneumatic tire according to claim 1, wherein, sequentially from the contact end, the shoulder surface has a flat surface, a first curved surface that forms the arc shape, and a second curved surface that is curved to project inward in the tire axial direction.

10. The pneumatic tire according to claim 9, wherein the flat surface tilts at an angle of 30° to 50° with respect to a virtual line passing through the contact end along a tire radial direction, and
a length of the flat surface in the tire radial direction is shorter than a length of the first curved surface in the tire radial direction.
